(19) United States
(12) Patent Application Publication
(10) Pub. No.: US 2006/0002250 A1
(43) Pub. Date: Jan. 5, 2006

(54) Information recording apparatus and information recording medium

(75) Inventors: Akira Shirota, Saitama (JP); Masahiro Kato, Saitama (JP); Kunihiko Horikawa, Saitama (JP)

Correspondence Address: NIXON & VANDERHYE, PC, 901 NORTH GLEBE ROAD, 11TH FLOOR, ARLINGTON, VA, 22203, US

(73) Assignee: Pioneer Corporation, Tokyo (JP)

(21) Appl. No.: 11/171,501

(22) Filed: Jul. 1, 2005

(30) Foreign Application Priority Data
Jul. 5, 2004 (JP) 2004-198400

(51) Int. Cl. G11B 7/00

(52) U.S. Cl. 369/44.27; 369/44.25

(57) ABSTRACT

An information recording apparatus is provided with: an optical head which can optically write information onto an information recording medium; a focusing device for performing such focusing that a focus position of the optical head is set onto a recording reference plane of the information recording medium; and a controlling device for controlling the focusing device to shift the focus position from the recording reference plane by an offset value in order to correct an influence of aberration and controlling the optical head to perform writing in such a condition that the focus position is shifted.

### BACKGROUND OF THE INVENTION

1. Field of the Invention

The present invention relates to an information recording medium, such as a DVD, and an information recording apparatus, such as a DVD recorder, for recording information onto the information recording medium.

2. Description of the Related Art

As this type of the information record medium, there is developed a dual layer type (i.e. two-layer type) or multiple layer type optical disc, in which a plurality of recording layers are formed on the same substrate. On the information recording apparatus, such as a DVD recorder, for performing the recording with respect to the two-layer type optical disc, laser light is focused on a recording layer located on the front as viewed from an optical head as being the light source of laser light (hereinafter referred to as an “L0 layer”, as occasion demands) to thereby write information into the L0 layer. Moreover, the laser light is focused on a recording layer located on the rear of the L0 layer as viewed from the optical head (hereinafter referred to as an “L1 layer”, as occasion demands), through the L0 layer, to thereby write information into the L1 layer.

Focus lead-in to the information which is written in each of the L0 layer and the L1 layer is performed on the basis of astigmatism method or the like, for example. Specifically, if an objective lens in the optical head is displaced in a direction approaching to the optical disc, a focus error signal of reflected light from, for example, a semitransparent reflective coating or film in the L0 layer converges to 0 when the L0 layer is focused. If the objective lens is further displaced in the direction approaching to the optical disc, a focus error signal of reflected light from a reflective coating in the L1 layer converges to 0 when the L1 layer is focused.

As described above, if the objective lens is displaced closer to the optical disc, the focus error signal with two S-shaped waveforms in which the center of the two S-shaped waveforms are the position of the objective lens when the L0 layer is focused (hereinafter referred to as an “in-focus position” of the L0 layer, as occasion demands) and the position of the objective lens when the L1 layer is focused (hereinafter referred to as an “in-focus position” of the L1 layer, as occasion demands)is obtained. If the position of the objective lens is displaced on the basis of the signal with the two S-shaped waveforms, each of the L0 layer and the L1 layer can be focused (e.g. refer to Japanese Patent Application Laid Open NO. 2000-311346 and NO. 2001-23237).

### SUMMARY OF THE INVENTION

In practice, however, such an adjustment alone that the S-shaped signal converges to “0” or such an adjustment alone that the focus position is set onto the zero cross point of the focus S-shaped curve does not always mean that the focus of the object lens is appropriately adjusted, specially on the two-layer type optical disc. For example, because of a difference in aberration conditions of the L0 layer and the L1 layer, it is difficult to design the object lens to prevent spherical aberration in both of the L0 layer and the L1 layer.

Thus, there is such a technical problem that the object lens is away from a truly optimum position (i.e. a recording position in the depth direction of an optical axis in the L0 layer or the L1 layer where the most ideal reproduction signal can be written reproducibly from the various viewpoints of jitter, symmetry, and the like in the reproduction) with the above-mentioned adjustment alone. Even on a single-layer disc, the same problem arises if the spherical aberration is considerably large according to specifications, manufacturing errors, or the like.

It is therefore an object of the present invention to provide: an information recording medium on which information is appropriately recorded by the optimization of writing conditions and the recorded information can be reproduced in a good condition, and an information recording apparatus which can appropriately record the information by the optimization of writing conditions wherein the recorded information can be reproduced in a good condition.

(Information Recording Apparatus)

The information recording apparatus of the present invention will be explained hereinafter.

The above object of the present invention can be achieved by an information recording apparatus provided with: an optical head which can optically write information onto an information recording medium; a focusing device for performing such focusing that a focus position of the optical head is set onto a recording reference plane of the information recording medium; and a controlling device for controlling the focusing device to shift the focus position from the recording reference plane by an offset value and controlling the optical head to perform writing in such a condition that the focus position is shifted.

According to the information recording apparatus of the present invention, before the actual data writing operation, the focus position of the optical head with respect to the information recording medium is shifted from the recording reference plane, on the basis of the offset value. This type of correction (e.g. shifting) of the focus position is performed by adjusting the position of the objective lens in the optical head. Here, the “optical head” includes a beam light source, such as a semiconductor laser, and an optical system, such as an objective lens for introducing a laser beam from the light source to the information recording medium to come into focus. The “focusing device” is a device, which is called a focus servo system, for adjusting a relative position of the optical head and the information recording medium, and indicates a mechanical device or electromagnetic device which displaces the objective lens of the optical head along the optical axis. Moreover, the “recording reference plane” means a plane or surface which is the reference of recording on the information recording medium in the optical writing by the optical head. For example, the “recording reference plane” of the present invention is a plane parallel to the disc surface including the zero cross point of the focus S-shaped curve in the signal waveform of a focus signal in recording, with respect to the optical disc which is one example of the information recording medium. Such a recording reference plane is typically a plane parallel to a disc substrate plane which is located inside the recording layer or the surface of a recording layer on the optical disc or.

If the focusing is performed by the conventional astigmatism method or the like, the focus position in recording is supposed to be optimum. However, according to the findings of the inventors of the present invention, this type of adjustment alone sometimes cannot set the focus position onto the optimum position. For example, in the case of the two-layer type disc, it is difficult to prevent the occurrence of the spherical aberration in both of the L0 layer and the L1 layer. Namely, the objective lens is designed to prevent the spherical aberration when the L0 layer or the L1 layer is focused, in consideration of refraction by the surface of the optical disc.

However, since the L0 layer and the L1 layer have different depths from the surface of the optical disc, if the objective lens is designed to prevent the spherical aberration in the L0 layer, for example, then, the spherical aberration occurs in the L1 layer which is away from the L0 layer. On the contrary, if the objective lens is designed to prevent the spherical aberration in the L1 layer, the spherical aberration occurs in the L0 layer. Thus, there is nothing but to design the objective lens to correct the aberration in either of the L0 layer and the L1 layer, or to correct on the basis of a middle position of the both. It is difficult in principle to completely eliminate the influence of the spherical aberration from the both recording layers, by the lens designing. Moreover, it is also difficult to prepare the two-layer type disc in which the spherical aberration does not occur in the both recording layers.

Thus, in the present invention, the focus position of the objective lens with respect to the recording layer of the optical disc is set onto a position where the focus position by the normal focusing is defocused, to thereby set the focus position onto a substantially optimum position. In this case, the optical system such as the objective lens and the disc as the recording object in existence can be used.

Incidentally, the “optimum position” herein is not a recording position in the depth direction of the optical axis, including the zero cross point of the focus S-shaped curve in recording. It means a recording position in the depth direction of the optical axis in the L0 layer or the L1 layer where a reproduction signal with the most ideal various reproduction features, such as a radial push-pull value, an asymmetry value, modulated amplitude, and a jitter value at a time of reproduction, can be written reproducibly.

According to the information recording apparatus of the present invention, the focus position is shifted by the offset amount (i.e. the offset value), to thereby eliminate the influence of aberration at the focus position, specifically, the influence of spherical aberration.

For example, as a method of correcting the spherical aberration, there is known a method of incorporating a liquid crystal part into the optical system in the optical head and using a change of the refractive index of the liquid crystal. In the present invention, the aberration is not directly corrected in the above-mentioned manner. In the present invention, the focus position is optimized by comprehensively considering factors which influence the shape of the focus position of the light beam, to thereby act to reduce or eliminate the influence of aberration or the like in the end at the time of reproduction. Thus, in the present invention, only the focusing device is controlled on the basis of the offset value, so that it is possible to realize the present invention, more simply, in terms of an apparatus structure and control.

As described above, it is tried to eliminate the influence of aberration in the writing. Thus, the writing is performed after the focus position is adjusted to a truly optimum position, and it is possible to perform the recording of the information in which a reproduction signal with the best feature can be obtained, even for the optical disc with large spherical aberration.

In one aspect of the information recording apparatus of the present invention, the offset value is set on the basis of a central point of a focus S-shaped curve in a signal waveform of a focus error signal which is used when the focusing device performs the focusing.

According to this aspect, at first, the focus position of the optical head is adjusted to a position corresponding to the central point of the focus S-shaped curve, and then, the focus position is fine-adjusted by the offset value. Alternatively, the focus position of the optical head is directly adjusted to a position which is shifted by the offset value from the position corresponding to the central point of the focus S-shaped curve.

In another aspect of the information recording apparatus of the present invention, the offset value is recorded in advance on the information recording medium, the optical head can read the information from the information recording medium, and the controlling device controls the focusing device to shift the focus position by the offset value which is read by the optical head from the information recording medium.

According to this aspect, the offset value which is recorded in advance on the information recording medium is read and used for the correction of the focus position. Namely, the offset value is possessed as peculiar information to each information recording medium, and it is enough to read the offset value from the information recording medium. Thus, it is possible to easily obtain the offset value appropriate for each information recording medium, without measurement or the like. Incidentally, the “optical head” in this case is shared for writing and for reading, and is constructed to output a light beam with a different power in each case.

In another aspect of the information recording apparatus of the present invention, first optical information which defines the offset value and which is related to the information recording medium is recorded in advance on the information recording medium, the optical head can read the information from the information recording medium, and the controlling device possesses second optical information which defines the offset value and which is related to the optical head, in advance, and sets the offset value on the basis of the first optical information which is read by the optical head from the information recording medium and the second optical information possessed in advance.

According to this aspect, the first optical information which defines the offset value, i.e., the optical information as for the information recording medium required for the setting of the offset value is recorded on the information recording medium. This first optical information is read by the information recording apparatus. On the other hand, the second optical information which defines the offset value, i.e. the optical information as for the optical head required for the setting of the offset value is recorded in a memory built in the information recording apparatus. At the time of recording, the offset value is set on the basis of the first optical information and second optical information. For example, the information recording apparatus can be constructed to have a table in advance which uses the optical information as parameters and to input the first optical information and the second optical information to thereby output the offset value.

In this case, the offset value is obtained in consideration of the optical condition of the information recording apparatus. Thus, it is possible to correct the aberration, more realistically.

In another aspect of the information recording apparatus of the present invention, the optical head can read the information from the information recording medium, and the controlling device controls the optical head and the focusing device to perform writing at each of a plurality of points on the information recording medium while changing the focus position, controls the optical head to read the information from the plurality of points, obtains a predetermined type of a reproduction feature related to a reproduction signal corresponding to the read information, and sets the offset value on the basis of the obtained reproduction feature.

According to this aspect, the offset value is obtained before the writing of the information to be written onto the information recording medium (hereinafter this type of writing is referred to as “real recording”, as occasion demands). Thus, it is possible to obtain the offset value corresponding to the condition immediately before the real recording, in the system provided with the information recording medium and the information recording apparatus, and it is possible to properly correct the focus position.

The offset value here is set on the basis of the reproduction feature of the test-written information. Namely, setting the focus position to a position “where the writing can be performed, reproducibly, with the best reproduction feature” indicates the optimization in focusing in this case, and the focus position is corrected to such a focus position according to the offset value.

Therefore, in this aspect, it is possible to perform the writing in a good condition by shifting the focus position only by the offset value, and it is possible to read the reproduction signal with the good reproduction feature.

In the present invention, the reproduction feature may be at least one of a radial push-pull value, an asymmetry value, modulated amplitude, and a jitter value.

The above-mentioned parameters are all widely used for the estimation of whether the reproduction condition is good or bad. If the focus position of the optical head is corrected on the basis of these parameters, it is possible to perform the writing with the good reproduction feature. Specifically, a focus position which satisfies at least any one of such conditions of the reproduction feature that (i) the asymmetry is the maximum, (ii) the modulated amplitude is the maximum, and (iii) the jitter value is the minimum, may be set as the offset value. Incidentally, with respect to these features, a single feature may be used, or the mean value may be used if two or more features are used.

Moreover, the controlling device may control the focusing device to change the focus position on the basis of a position where the focusing is performed on an offset reference medium, in writing which is performed at the time of setting the offset value.

In this case, the writing related to the setting of the offset value is performed a plurality of times, with the focus position changed for each writing point, on the basis of the focus position which is adjusted in advance by the focusing with respect to the offset reference medium (e.g. by using this focus position as the center or a starting point). The “offset reference medium” is used not for the actual writing but for the setting of the focus position in the initial condition in the adjustment of the focus position, so that the “offset reference medium” is a recording medium which is a reference. In this case, whether or not the recording or reproduction can be actually performed on the offset reference medium is not an issue.

In this case, it is possible to set the focus position in the initial condition to a desired position in accordance with the optical condition of the offset reference medium, e.g. the thickness and the refractive index of a substrate, or the like. Moreover, the focus position in the initial condition can be set in the vicinity of a position to be set in the end where the reproduction feature is good to some extent, so that it is possible to set the offset value, efficiently and properly.

Alternatively, the controlling device may control the focusing device to change the focus position on the basis of a position where the radial push-pull value is the maximum in an unrecorded portion of the information recording medium, in writing which is performed at the time of setting the offset value.

In this case, the writing related to the setting of the offset value is performed by changing the focus position on the basis of the focus position which is adjusted in advance to have the maximum radial push-pull value in the unrecorded portion.

Thus, the focus position in the initial condition can be set in the vicinity of a position where the reproduction feature is good to some extent, i.e. a position to be set in the end, so that it is possible to set the offset value, efficiently and properly.

Moreover, in this case, the adjustment of the focus position which is the same as in the above-mentioned offset reference medium is performed by using the information recording medium which is the recording object. Thus, a time and a load for the replacement of the information recording medium are unnecessary, and it is possible to match the optical condition, such as the thickness of a middle layer and a substrate, with a condition in the actual writing.

Furthermore, the controlling device may control the focusing device to change the focus position on the basis of a position where the reproduction feature is optimized in a portion on which the information is pre-written in advance (i.e. the pre-written portion) or a portion on which the information is written for the setting (i.e. the written portion)in the information recording medium, in writing which is performed at the time of setting the offset value.

In this case, the writing related to the setting of the offset value is performed by changing the focus position on the basis of the focus position which is adjusted in advance to optimize the reproduction feature in a recording area. The recording area may be a pre-write area where information is already written before the series of writing operation, or may be a portion where information is written for the setting of the offset value in the series of the writing operation. The reproduction feature herein may be the radial-push pull value, the asymmetry value, the modulated amplitude, the jitter value, or the like, as described above, for example. In this case, it is also possible to obtain the same effect as the previous aspect.

In addition, the controlling device may control the optical head and the focusing device to perform Optimum Power Control (OPC) processing, at least one time of before writing which is performed at the time of setting the offset value and after shifting the focus position by the offset value.

In this case, the writing in the detection of the offset value is performed on the basis of the focus position after the OPC processing, i.e. the calibration of the laser power. If the laser power is calibrated in advance, the influence of the laser power is eliminated from the reproduction feature of a reproduction signal, so that it is possible to obtain the reproduction feature, more properly.

Moreover, after the correction of the focus position by the offset value, the OPC processing is further performed, and then, information is actually written. If the focus position is shifted by the correction, the proper value of the laser power varies as well. Thus, if the OPC processing is performed again in the actual writing, the writing can be performed with the optimum intensity of light, which can prevent the scatter (or dispersion) of the size of pits.

In another aspect of the information recording apparatus of the present invention, the controlling device controls the optical head and the focusing device to write the set offset value onto the information recording medium.

According to this aspect, the offset value which is once obtained by the above-mentioned setting or the like is stored on the information recording medium. Thus, if the stored offset value is read and used when the writing is performed again on the information recording medium, it is possible to realize the proper focusing, easily, which is advantageous.

In another aspect of the information recording apparatus of the present invention, if the information recording medium is provided with a plurality of recording layers, the controlling device controls the focusing device to shift the focus position by the offset value, with respect to each recording reference plane of the plurality of recording layers.

According to this aspect, in the case of the information recording medium of a multilayer type, focusing at any one of the recording layers does not always mean making an appropriate focus adjustment with respect to the other recording layers. However, by focusing each of the recording layers as described above, it is possible to realize the appropriate focus adjustment.

(Information Recording Medium)

The information recording medium of the present invention will be explained hereinafter.

The above object of the present invention can be also achieved by a first information recording medium onto which information can be optically written by an optical head provided for an information recording apparatus, the information recording medium provided with: a writing area to record therein an offset value which is set to correct a focus position of the optical head, or optical information of itself which defines the offset value.

According to the first information recording medium of the present invention, the area where the above-mentioned offset value or the optical information of itself required for the acquirement of the offset value can be written is prepared in advance. Namely, it is possible to write the offset value and the optical information or the like onto the information recording medium after the correction of the focus position described above. When the next information is written by the information recording apparatus of the present invention, the information as for the offset value and the optical information or the like can be provided for the correction of the focus position, and it is possible to reduce such a load of the information recording apparatus that is the acquirement of the offset value.

The above object of the present invention can be also achieved by a second information recording medium provided with: a writing area into which information can be optically written by an optical head provided for an information recording apparatus, wherein an offset value which is set to correct a focus position of the optical head, or optical information of itself which defines the offset value is recorded in advance in the writing area.

According to the second information recording medium of the present invention, the above-mentioned offset value or the optical information of itself required for the acquirement of the offset value is written in advance. Thus, the information recording medium can provide the information as for the offset value and the optical information or the like for the correction of the focus position which is performed before the information writing by the information recording medium of the present invention, and it is possible to reduce such a load of the apparatus side that is the acquirement of the offset value.

Moreover, as a result, information can be written onto the information recording medium after the correction of the focus position described above, so that the influence of aberration is eliminated, and it is possible to perform the writing reproducibly with the good reproduction feature.

In one aspect of the first or second information recording medium of the present invention, the information recording medium is provided with a plurality of recording layers, each of which has the writing area, and the offset value or the optical information with respect to each layer of the plurality of recording layers is a recording object in at least one of the writing areas of the plurality of the recording layers.

According to this aspect, if the offset value recorded correspondingly to each of the plurality of recording layers, or the optical information of the information recording medium itself which defines the offset value is read and used for the setting of the offset value, then, it is possible to make a focus adjustment with respect to all the recording layers, properly. The offset value or the optical information in this case may be recorded in advance, or may be recorded into a predetermined writing area in the previous writing.

As explained above, according to the information recording apparatus of the present invention, it is provided with: the optical head; the focusing device; and the controlling device. Thus, it is possible to reduce or eliminate the influence of aberration by correcting the focus position, and it is possible to write information onto the information recording medium such that the reproduction can be performed in a good condition.

Moreover, according to the first or second information recording medium of the present invention, it is provided with: the area where the information writing can be performed; and the area where the offset value or the optical information is written. Thus, it is possible to reduce or eliminate the influence of aberration by correcting the focus position, to thereby perform the information writing such that the reproduction can be performed in a good condition.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1A and FIG. 1B are a schematic plan view showing the basic structure of an optical disc in a first embodiment of the present invention (FIG. 1A), and a schematic cross sectional view of the optical disc and a corresponding conceptual diagram showing a recording area structure in the radial direction (FIG. 1B);

FIG. 2 is a block diagram showing the structure of an information recording/reproducing apparatus in the first embodiment;

FIG. 3 is a flowchart showing an operational procedure at the time of writing of the information recording/reproducing apparatus in the first embodiment;

FIG. 4A, FIG. 4B, and FIG. 4C are conceptual diagrams to explain an operation at the time of offset-value setting by the information recording/reproducing apparatus in the first embodiment, wherein FIG. 4A, FIG. 4B, and FIG. 4C individually show a different focus position;

FIG. 5 is a graph showing a change of a jitter value with respect to the focus position, which is measured at the time of offset-value setting in an L0 layer (a layer closer to laser light) in the first embodiment;

FIG. 6 is a graph showing a change of modulated amplitude with respect to the focus position, which is measured at the time of offset-value setting in the L0 layer (a layer closer to laser light) in the first embodiment;

FIG. 7 is a graph showing a change of the jitter value with respect to the focus position, which is measured at the time of offset-value setting in an L1 layer (a layer farther from laser light) in the first embodiment;

FIG. 8 is a graph showing a change of the modulated amplitude with respect to the focus position, which is measured at the time of offset-value setting in the L1 layer (a layer farther from laser light) in the first embodiment;

FIG. 9 is a graph showing a change of the jitter value with respect to the focus position, which is measured at the time of offset-value setting on a single-layer information recording medium in a comparison example of the first embodiment;

FIG. 10 is a graph showing a change of modulated amplitude with respect to the focus position, which is measured at the time of offset-value setting on a single-layer information recording medium in a comparison example of the first embodiment;

FIG. 11 is a conceptual diagram to explain an optical disc and an operation at the time of writing of the optical disc by an information recording/reproducing apparatus in a second embodiment; and

FIG. 12 is a conceptual diagram to explain an optical disc and an operation at the time of writing of the optical disc by an information recording/reproducing apparatus in a third embodiment.

### DETAILED DESCRIPTION OF THE PREFERRED EMBODIMENTS

(First Embodiment)

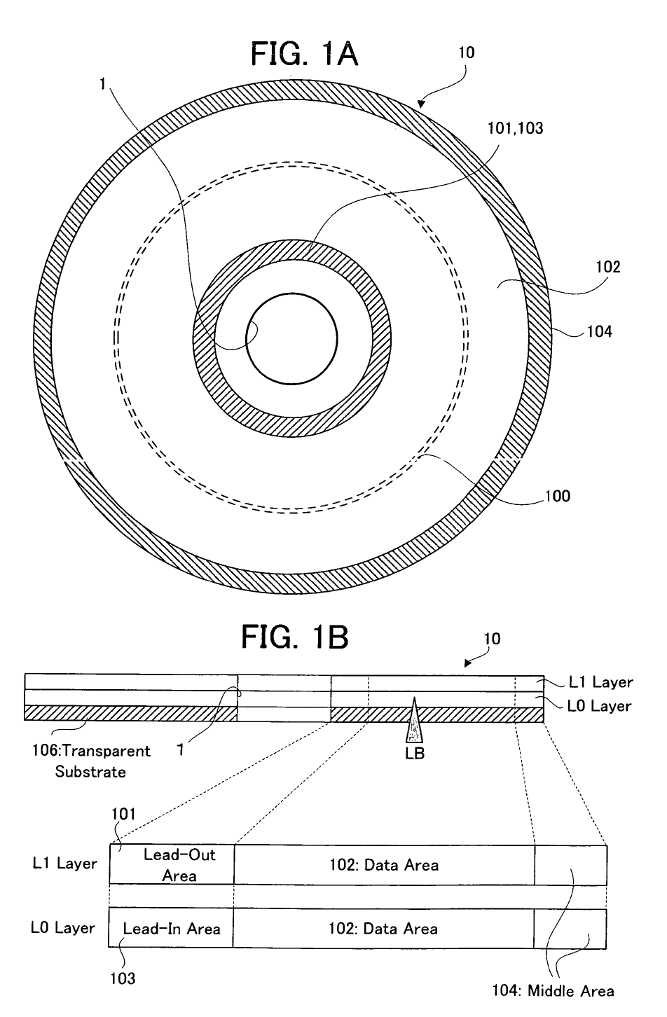

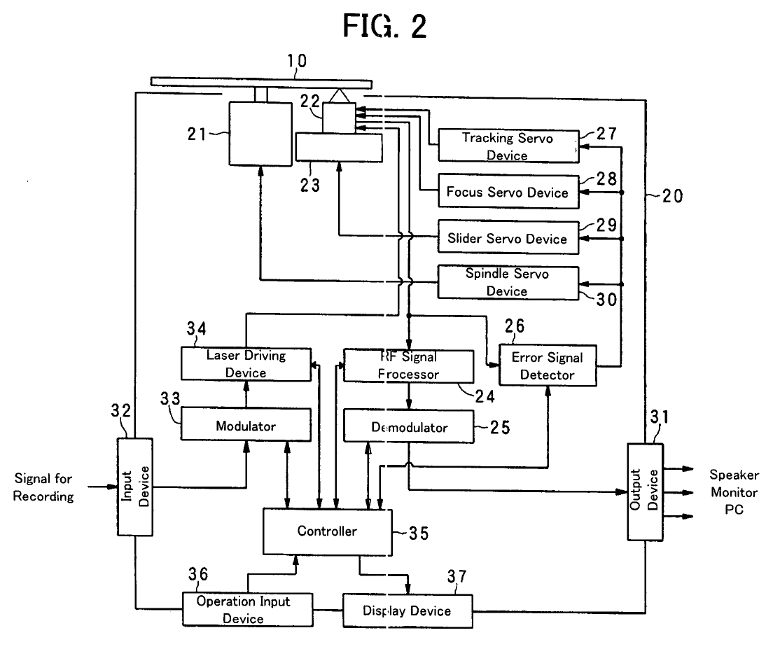

The first embodiment of the present invention will be explained with reference to FIG. 1 to FIG. 10.

At first, an information recording medium in the first embodiment will be explained with reference to FIG. 1A and FIG. 1B. FIG. 1A is a schematic plan view showing the basic structure of an optical disc in the first embodiment, and FIG. 1B is a schematic cross sectional view of the optical disc and a corresponding conceptual diagram showing a recording area structure in the radial direction.

As shown in FIG. 1A and FIG. 1B, an optical disc 10 is disc-shaped with a diameter of about 12 cm, as is a DVD, and is a two-layer type in which an L0 layer and an L1 layer are laminated on a transparent substrate 106. On two recording planes, each corresponding to respective one of the L0 layer and the L1 layer, there are provided a lead-in area 101; a data area 102; and a lead-out area 103 or a middle area 104, with a center hole 1 as the center. For example, a PC area 1 for OPC (Optimum Power Control) processing is prepared in the lead-in area 101 in the L0 layer and the lead-out area 103 in the L1 layer. Management information, and the like are recorded in the lead-in area 101 in the L0 layer and the lead-out area 103 in the L1 layer. In these recording areas on the recording planes, tracks 100, such as groove tracks and land tracks, are placed, spirally or concentrically, with the center hole 1 as the center. On the track 100, data is recorded by a unit of ECC block.

On such an optical disc 10, the focus position of laser light LB, which is emitted from the bottom to the top of FIG. 1B, is set onto either of the recording planes of the L0 layer and the L1 layer, to thereby perform the recording and reproduction of the information in the L0 layer or the L1 layer.

Incidentally, a semitransparent reflective coating is provided between the L0 layer and the L1 layer, and furthermore, a reflective coating and a protective coating are provided on the L1 layer. The L1 layer and the reflective coating may be formed by directly growing a film on (or directly coating) the L0 layer and the semitransparent reflective coating etc. which are formed on the transparent substrate 106. Alternatively, after growing them on another substrate, the substrates may be pasted. On the optical disc 10, spherical aberration caused by the scatter of the film thickness causes a trouble at the time of recording/reproduction, as described later.

Next, an information recording apparatus in the first embodiment will be explained with reference to FIG. 2. FIG. 2 shows the structure of the information recording apparatus in the first embodiment.

In FIG. 2, an information recording/reproducing apparatus 20 as being one example of the “information recording apparatus” of the present invention has a function of recording information onto the optical disc 10 and a function of reading the information recorded on the optical disc 10, under the control of a control device 35. Namely, the information recording apparatus of the present invention is provided with a function related to the information recording of the information recording/reproducing apparatus 20.

The information recording/reproducing apparatus 20 is provided with: a spindle motor 21; an optical head 22; a slider 23; and the like, as a mechanism device. It is also provided with: a RF signal processor 24; a demodulator 25; a modulator 33; a laser driving device 34; and the like, as a signal system. It is also provided with: an error signal detector 26; a tracking servo device 27; a focus servo device 28; a slider servo device 29; a spindle servo device 30; and the like, as a servo system. It is also provided with: an output device 31; an input device 32; an operation input device 36; a display device 37; and the like, as an interface. Moreover, it is also provided with a controller 35 for controlling the above-mentioned various constituent elements.

The spindle motor 21 rotates the optical disc 10 which is mounted thereon, at a predetermined rotational speed, i.e., the predetermined number of rotations, or at a predetermined linear velocity. The rotation control is performed by detecting rotational errors on the basis of various synchronizing signals on the error signal detector 26 from a reproduced signal, generating a control signal on the spindle servo device 30 on the basis of the detected rotational errors, and giving a feedback to the spindle motor 21.

The optical head 22 has a function of optically writing information onto the optical disc 10 and a function of optically reading it. The optical head 22 is shared for reading and writing, or is individually provided for reading and for writing. The optical head 22 focuses the laser light on a predetermined portion on the track 100 of the optical disc 10 at the time of writing, to thereby cause a thermal destruction or a phase change or the like in that portion to form a pit. At the time of reading, the optical head 22 focuses the laser light on the pit and detects the reflected light to read the information. Thus, it is necessary to control the focus position of the laser light in a focus direction and a tracking direction, in order to focus the laser light and follow the track 100. This control can be realized as a feedback control, in which the errors of the focus and the tracking are detected on the error signal detector 26 from the reproduction signal read by the optical head 22, control signals are individually generated on both the focus servo device 28 and the tracking servo device 27 on the basis of the errors, and the control signals are inputted to the optical head 22.

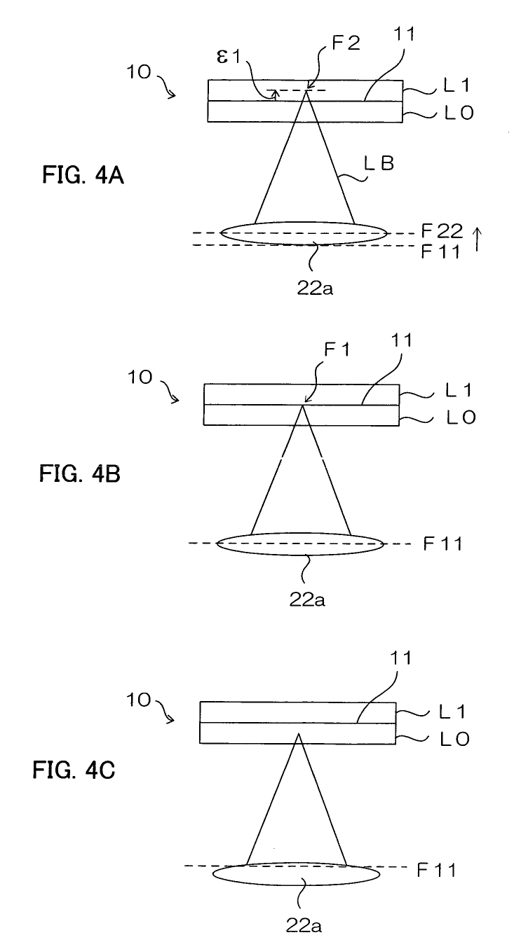

Here, the focus servo device 28 corresponds to one specific example of the “focusing device” of the present invention. The focus servo device 28 is constructed to displace an objective lens 22a (refer to FIG. 4) in the optical head 22, in the vertical direction of FIG. 2, in order to adjust the focus position of the optical head 22. When a signal for recording, which is inputted from the input device 32, is written onto the optical disc 10, the focus servo 28 is controlled to displace the objective lens 22a such that the focus position shifts from the recording plane, in accordance with an offset value ε1 which is inputted from the controller 35.

Incidentally, the offset value ε1 is the amount of offset with respect to a focus distance, to correct the influence of aberration on the optical disc 10, particularly, the spherical aberration, and this value is set by the controller 35. Moreover, the actual adjustment of the focus position is performed by the position control of the objective lens 22a, so that the offset value ε1 and the focus position may be converted to position coordinates of the objective lens 22a.

The error signal detector 26 generates a push-pull signal (i.e. a push-pull error signal or a tracking error signal), as one of the control signal by using a push-pull method or a differential push-pull method. On the basis of this, tracking servo is performed by the tracking servo device 27. With respect to the tracking control, the position control in the disc radial direction by the slider 23 may be also added.

The slider 23 is a feeding mechanism for displacing the optical head 22 in the radial direction of the optical disc 22. For example, a mechanism of feeding a base on which optical head 22 is mounted by using screws or a similar mechanism is generally used.

The RF signal processor 24 converts a Radio Frequency (RF) signal reproduced by the optical head 22, to a signal appropriate for signal processing at a subsequent stage. The demodulator 25 has a function of demodulating the signal processed at the previous stage on the RF signal processor 24. The demodulator 25 also has an error correction function. A demodulation signal is outputted through the output device 31 to a speaker in the case of information as for sound, to a monitor in the case of information as for video, and to a personal computer or the like in the case of information as for data. The modulator 33 has a function of converting a signal for recording, which is inputted from the input device 32, to a predetermined format. A modulated signal is inputted to the laser driving device 34. The laser driving device 34 modulates the laser light emitted from the optical head 22, on the basis of the inputted modulated signal, to irradiate the optical disc 10 with it.

The controller 35 is provided with a CPU or the like. The controller 35 controls the whole operation of the information recording/reproducing apparatus 20, on the basis of the information from the various function devices, or an operational command from the operation input device 36, or the like, and displays the operation state of the information recording/reproducing apparatus 20 on the display device 37. The input device 36 may be provided with a predetermined mechanical input device, or may have a remote control structure. With respect to the display device 37, a CRT, a liquid crystal display apparatus, an EL display apparatus, or the like can be used.

The controller 35 in the first embodiment corresponds to one specific example of the “controlling device” of the present invention. The controller 35 sets the offset value ε1 in the writing with respect to the optical disc 10, and controls the focus servo device 28 to shift the focus position of the optical head 22 from the recording plane by the offset value ε1. In addition, the controller 35 controls the optical head 22 to perform the writing in the condition that the focus position is shifted.

Moreover, the controller 35 controls the focus servo device 28 to set the focus position of the optical head 22 onto the recording plane, in the “reproduction” with respect to the optical disc 10. Namely, the controller 35 uses the offset value ε1 only at the time of recording, and controls the focus servo device 28 not to shift the focus position from the recording plane (i.e. to set the focus position on the zero cross point of the focus S-shaped curve) at the time of reproduction.

The controller 35, however, may set the offset value ε1 in the “reproduction” with respect to the optical disc 10, and may control the focus servo device 28 to shift the focus position of the optical head 22 from the recording plane by the offset value ε1. In addition, the controller 35 may control the optical head 22 to perform the reproduction in the condition that the focus position is shifted. Namely, the controller 35 may control the focus servo device 28 to shift the focus position by the offset value ε1, by using the offset value ε1 not only at the time of recording, but also at the time of reproduction.

(Flow of Recording Operation by Information Recording Apparatus of the Present Invention)

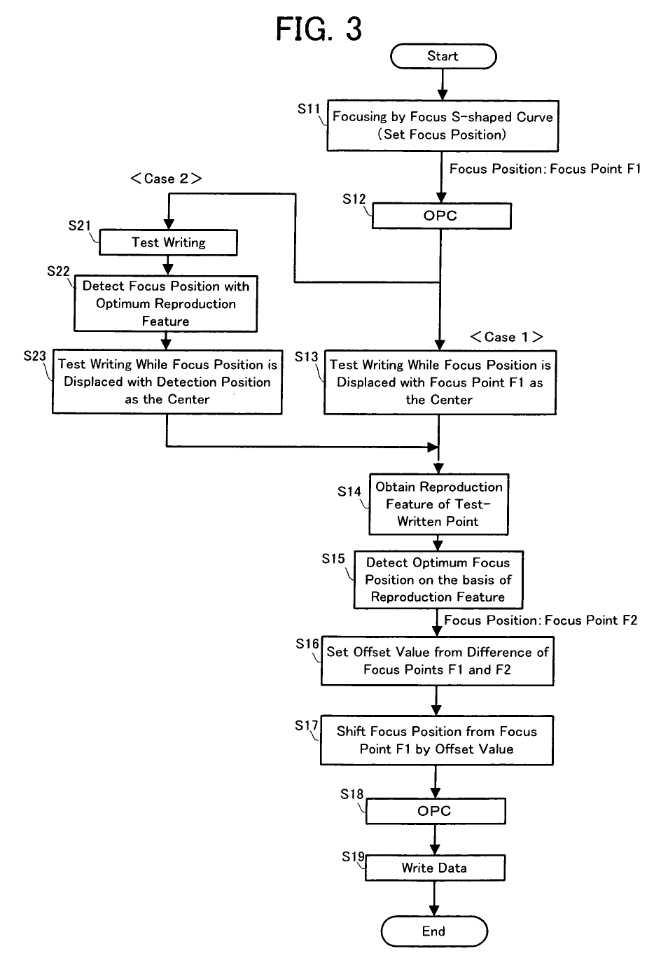

Next, a recording operation with respect to the optical disc 10 by the information recording/reproducing apparatus 20 will be explained with reference to FIG. 3 and FIG. 4. FIG. 3 shows a writing procedure with respect to the optical disc 10 by the information recording/reproducing apparatus 20. FIG. 4A, FIG. 4B, and FIG. 4C show a change of the focus position of the optical head 22 by the offset value ε1.

An operation related to the correction of the focus position which will be explained below, may be performed continuously for both the L0 layer and the L1 layer before the actual writing operation, or may be performed only for the L0 layer (or the L1 layer) if the writing is performed only in the L0 layer (or the L1 layer). Alternatively, at first, the focus position is corrected with respect to the L0 layer, and if there is a large amount of writing information and it is necessary to write it in the L1 layer as well, then, the correction of the focus position may be performed for the L1 layer before the writing into the L1 layer. Namely, the writing order can be set arbitrarily. However, the spherical aberration, which is the issue here, is actualized particularly on the L1 layer side, so that the focus position may be corrected by the offset value ε1 only in the L1 layer.

Thus, for convenience, the case of the L1 layer will be mainly explained, as for the correction of the focus position by the offset value ε1, and an explanation for the case of the L0 layer will be omitted as occasion.

On the flowchart in FIG. 3, in the writing onto the optical disc 10, at first, the controller 35 controls the focus servo device 28 to perform focusing by the so-called focus S-shaped curve (step S11).

The writing operation is started by the controller 35 when a command is given from the operation input device 36 or when the optical disc 10 is loaded. In this initial process, the laser light LB is emitted while the objective lens 22a is displaced in the direction approaching to the optical disc 10, and a focus error signal is obtained. The focus error signal has two S-shaped waveforms of which the centers are the in-focus position of the L0 layer and the in-focus position of the L1 layer. The focus error signal converges to “0” at the two in-focus positions. For example, as shown in FIG. 4C to FIG. 4A, if the objective lens 22a is displaced in the direction approaching to the optical disc 10, the focus error signal from the L1 layer converges to “0” when a recording reference plane 11 of the L1 layer is in focus.

Then, the in-focus positions of the L0 layer and the L1 layer are detected, individually, from the zero cross point of the focus error signal. The in-focus position obtained in this manner is referred to as a focus point F1, and the position of the objective lens 22a at that time is referred to as a lens position F11 (refer to FIG. 4B). Then, the position of the objective lens 22a is set to the lens position F11.

Incidentally, the point where the focus error signal converges to “0” is the “zero cross point” of the focus S-shaped curve. In other words, a plane parallel to the substrate plane of the optical disc 10 including the focus position when the “zero cross point” is obtained or including the in-focus position, corresponds to one example of the “recording reference plane” of the present invention.

Then, the OPC processing is performed at the focus point F1 (steps S12), to thereby calibrate the intensity of the laser light LB. For example, by recording data for test writing into the PC area by sequentially changing the intensity of the laser light LB, reproducing the data for test writing, and judging the obtained reproduction signal on the basis of a predetermined estimation standard, it is possible to set the optimum intensity of laser light LB. If the laser power is calibrated in advance in this manner, the influence of the laser power is eliminated from the reproduction feature of the reproduction signal, so that it is possible to obtain the reproduction feature, more appropriately, in the following cases.

<Case 1>

Then, as shown in FIG. 4A to FIG. 4C, while the focus position is displaced, test writing is performed to set the offset value ε1 (step S13). The focus position is displaced step-by-step, from the focus point F1 as a starting point. The controller 35 controls the focus servo device 28 to change the position of the objective lens 22a, with the focus point F1 as the center. This test writing can be performed in an area for writing, which is provided in a predetermined location in the lead-out area 103 (or the lead-in area 101 in the case of the L0 layer).

Then, a reproduction signal is detected at a point where the test writing is performed, and its reproduction feature is obtained (step S14). The reproduction feature in this case may be features of a type used for the normal feature estimation. Specifically, a radial push-pull value, an asymmetry value, the modulated amplitude, a jitter value, and the like are listed. The feature which is adopted may be one of them, or may be two or more.

Incidentally, in the detection of the reproduction signal at this time, the controller 35 controls the focus servo device 28 to set the focus position of the optical head 22 onto the recording plane (i.e. to set the focus position onto the zero cross point of the focus S-shaped curve).

Then, on the basis of the obtained reproduction feature, the optimum focus point is detected (step S15). Namely, out of the focus position which is changed step by step, the position with the best reproduction feature is detected by the controller 35 on the basis of the obtained reproduction feature. The focus position detected in this manner is referred to as a focus point F2 herein, and the position of the object lens 22a when the focus position is the focus point F2 is referred to as a lens position F22 (refer to FIG. 4A).

Incidentally, if two or more of the reproduction features are obtained, the mean value of the optimum focus positions corresponding to respective reproduction features may be the focus point F2. For example, a radial push-pull signal and an asymmetry value may be obtained from a reproduction signal read from the test writing point, and a position with the maximum radial push-pull value and a position with the maximum asymmetry value are obtained. Then, the mean value of the two may be regarded as the focus point F2.

Then, a difference of the focus points F1 and F2 is set to the offset value ε1 (step S16), and the focus position of the objective lens 22a located at the lens position F11 is shifted to the lens position F22, to thereby shift the focus point F1 by the offset value ε1 (step S17).

Consequently, in the first embodiment, the focus position can be set onto the focus point F2. As seen from the setting procedure of the offset value ε1, the focus point F2 is a focus position “where the writing can be performed, reproducibly, with the best reproduction feature”, and the offset value ε1 is obtained as the error of an initial position (i.e. the focus point F1) with respect to the above-mentioned position (i.e. the focus point F2). In this process, the controller 35 sets the offset value ε1 and controls the focus servo device 28 on the basis of the offset value ε1, to thereby adjust the position of the objective lens 22a.

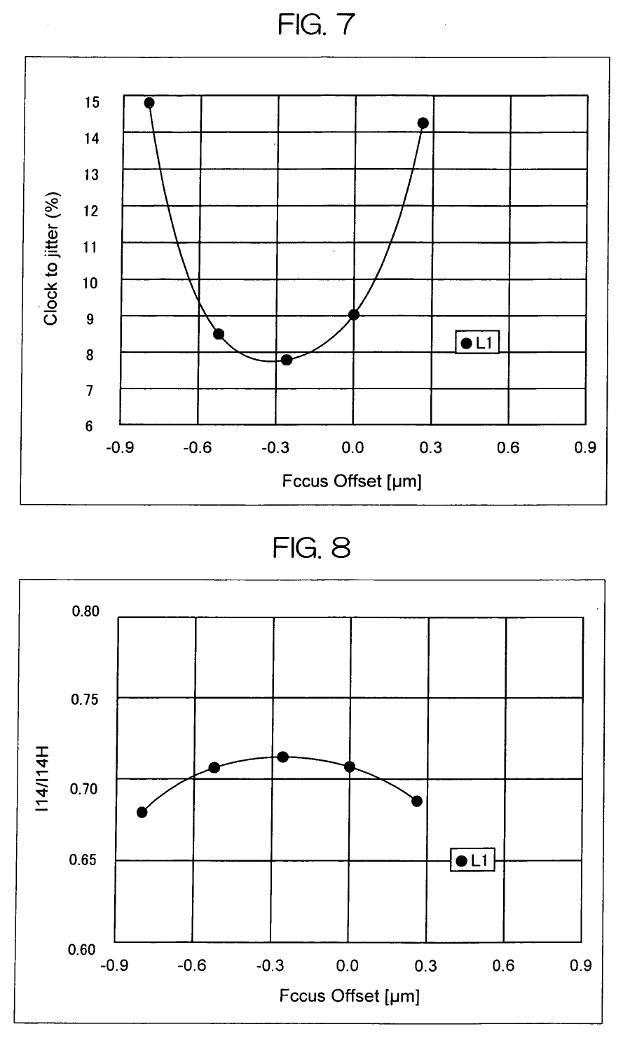

If the focus point F1 is the “optimum” focus point in the above-mentioned sense, the focus point F2 is eventually equal to the focus point F1. However, according to the experimental results by the inventors of the present invention, a position which is not the focus point F1 is the focus point F2 (refer to FIG. 7 and FIG. 8). Normally, the focus point F1 set by the S-shaped curve of the focus error signal is considered to be the in-focus position of the recording reference plane 11. However, in practice, there is a margin at the focus position itself, because of the influence of aberration or the like. In other words, the focus position varies, depending on which condition has a priority for the setting.

Thus, here, instead of the in-focus position, it is tried to select a position where the writing can be performed in a good condition in the end, as the focus position. Namely, it is possible to obtain the same results without correcting the aberration and the other optical parameters one by one.

Incidentally, in this case, although the reproduction feature is used as the index of the correction of the focus position, the focus position not in the reproduction but in the recording is used as a parameter. Thus, on the basis of this, it is possible to appropriately set the optical condition at the time of writing.

Then, in this state, the OPC processing is performed again (step S18). If the focus position is shifted by the correction, the appropriate value of the laser power of the optical head 22 becomes different. Thus, if the OPC processing is performed in the actual writing, the writing can be performed at the optimum intensity of light, and it is possible to obtain a reproduction signal with the good reproduction feature.

Then, the data is written onto the optical disc 10 (step S19). The data is a signal for recording, which is externally inputted to the input device 32, for example, and is inputted to the laser driving device 34 after the modulation by the modulator 33. Then, by the laser light LB modulated on the basis of this modulated signal, the data is written onto the optical disc 10.

The focus position at this time is away from the focus point F1, and is a focus position “where the writing can be performed, reproducibly, with the best reproduction feature”, as described above. Thus, it is possible to write a signal for recording in a good condition, and in the reproduction, it is possible to obtain a reproduction signal without error and with the good reproduction feature.

In the case 1 explained above, in setting the offset value ε1, test writing is performed while the focus position is displaced with the focus point F1 as the center (refer to the step S13). However, which position is set to the reference point (i.e. the center point) of displacement is not particularly limited, and various modification can be implemented. Some specific examples will be listed below.

<Case 2>

In the flowchart in FIG. 3, while the laser power and the focus position are maintained as in the setting after the OPC processing, test writing is performed (the step S21), and a focus position with the optimum reproduction feature is detected (the step S22). Then, while the focus position is changed again by using the detected position as the reference point, test writing is performed (step S23). The subsequent procedure is the same as in the case 1.

<Case 3>

In the case 3, without test writing, a reproduction signal is read from a pre-write area which is already recorded on the optical disc 10 (e.g. the lead-in area 101 and the lead-out area 103 or the like), and the reference point is detected on the basis of the reproduction feature.

<Case 4>

In the case 4, a position which gives the maximum radial push-pull value in an unrecorded portion of the optical disc 10 is regarded as the reference point. Namely, a reproduction signal is read from the unrecorded portion while the focus position is changed, and the focus position with the maximum radial push-pull value is detected and regarded as the reference point.

<Case 5>

In the case 5, the focus position when focusing is performed on an offset reference medium which is a reference is regarded as the reference point. Namely, a reproduction signal is read while the focus position is changed from the recording reference plane of the offset reference medium, and the focus position with the optimum reproduction feature is detected and regarded as the reference point.

The offset reference medium may be a reproduction-only medium, for example, and preferably has desired optical features, such as having little or no influence of aberration. Moreover, if the offset reference medium is the reproduction-only medium, it is also possible to perform the focusing by using the reproduction feature of already-recorded information.

In the case 1 to case 5, the reference point can be set in the vicinity of a position where the reproduction feature is good to some extent, i.e. the focus point F2, so that it is possible to set the offset value ε1, efficiently and appropriately.

<Measurement Example of Reproduction Feature Related to Offset Value Setting>

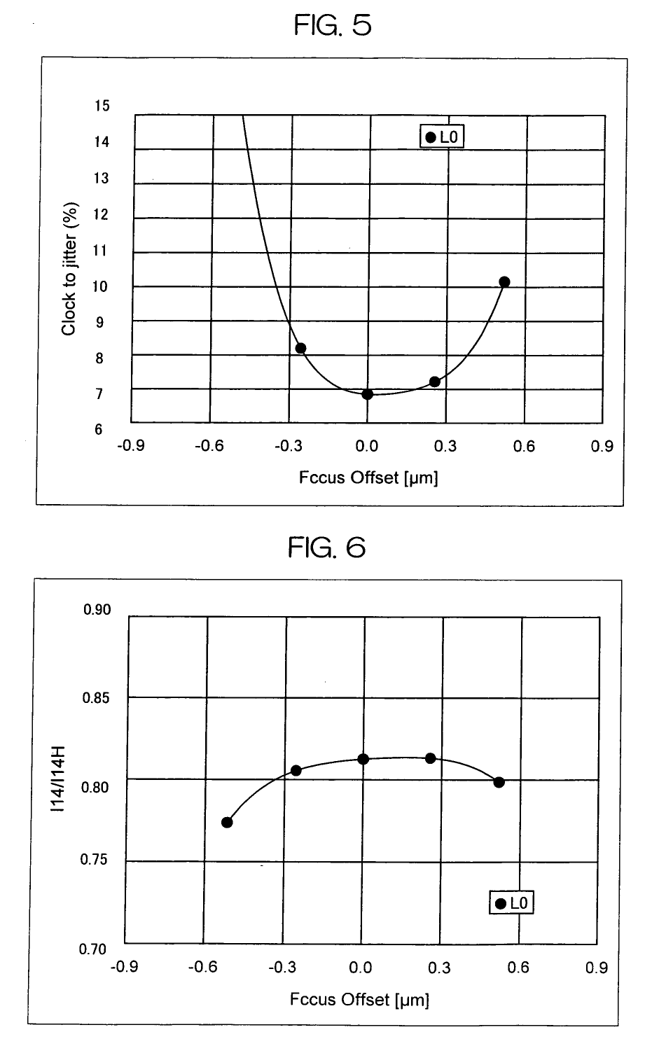

Next, out of the setting of the offset value ε1, the acquisition of the reproduction feature which is an index (a process corresponding to the steps S13 to S15) will be explained on the basis of experimental values in FIG. 5 to FIG. 10.

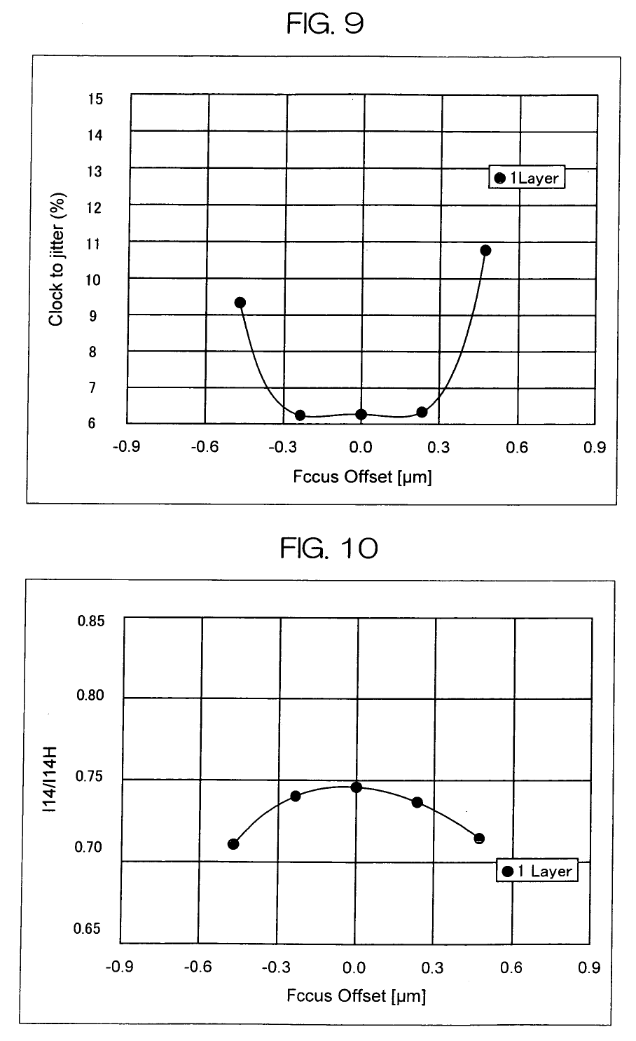

FIG. 5 and FIG. 6 show a jitter value and a modulated amplitude obtained in the L0 layer of the optical disc 10, respectively. FIG. 7 and FIG. 8 show a jitter value and a modulated amplitude obtained in the L1 layer of the optical disc 10, respectively. FIG. 9 and FIG. 10 show a jitter value and a modulated amplitude obtained on a single-layer information recording medium, respectively, as a comparison example. Incidentally, the horizontal axis in each of the figures indicates the coordinate axis of the focus position based on the focus point F1 (i.e. the focus position determined by the S-shaped curve of the error signal). In FIG. 4, the upper side from the reference point is negative, and the lower side is positive.

As shown in FIG. 5 and FIG. 6, in the L0 layer, when the focus position of the objective lens 22a is the focus point F1, the jitter value is the minimum and the modulated amplitude is the maximum. Thus, in the L0 layer in this case, the focus point F1 is the focus position “where the writing can be performed, reproducibly, with the best reproduction feature”. This is because the L0 layer side has less influence of aberration.

On the other hand, as shown in FIG. 7 and FIG. 8, in the L1 layer, at a point where the focus position of the objective lens 22a is shifted to the negative side from the focus point F1 by about 0.3 μm, the jitter value is the minimum and the modulated amplitude is the maximum. Namely, this shift amount (−0.3 μm) is set as the offset value.

As shown in FIG. 4A, the focus position in the L1 layer after the correction is shifted to the upper side from the focus point F1 by the offset amount value, and the laser light LB defocuses slightly to the upper side from the recording reference plane 11. This correction, however, excellently absorbs the influence of aberration or the like, so that it is possible to realize the writing in which the good reproduction feature can be obtained, as shown in FIG. 7 and FIG. 8.

Incidentally, as shown in FIG. 9 and FIG. 10, in the case of the single-layer disc in the comparison example, when the focus position of the objective lens 22a is the focus point F1, the jitter value is the minimum and the modulated amplitude is the maximum. Namely, in this case, the focus point F1 is the focus position “where the writing can be performed, reproducibly, with the best reproduction feature”. This is because the aberration is relatively small because of the single layer.

As described above, in the first embodiment, the focus position of the objective lens 22a with respect to the optical disc 10 is shifted on the basis of the offset value ε1 before the writing operation. Thus, the focus position is optimized and the influence of aberration of the laser light LB on the optical disc 10 (i.e. in the L1 layer in this case), specially, the influence of spherical aberration is eliminated. Therefore, it is possible to perform the writing in a good condition, and in the reproduction, it is possible to obtain a reproduction signal with an extremely little reproduction error and with the good reproduction feature.

Moreover, the writing at each of the plurality of points on the optical disc 10 is performed while changing the focus position, and the reproduction feature related to reproduction signals read from the plurality of points is obtained. Then, the offset value ε1 is set on the basis of the obtained reproduction feature. Thus, it is possible to obtain the offset value ε1 according to a condition just before the writing. In addition, the offset value ε1 is set on the basis of the reproduction feature in the test writing. Thus, according to this offset value ε1, the focus position of the optical head 22 can be set to the position “where the writing can be performed, reproducibly, with the best reproduction feature”. Therefore, it is possible to make a correction of the focus position, which considers the tolerance such as aberration, relatively easily.

Incidentally, as described above, it is tried to eliminate the influence of aberration in the writing, so that it is possible to perform the information recording in which a reproduction signal with the best reproduction feature can be obtained, even for the optical disc with large spherical aberration.

(Second Embodiment)

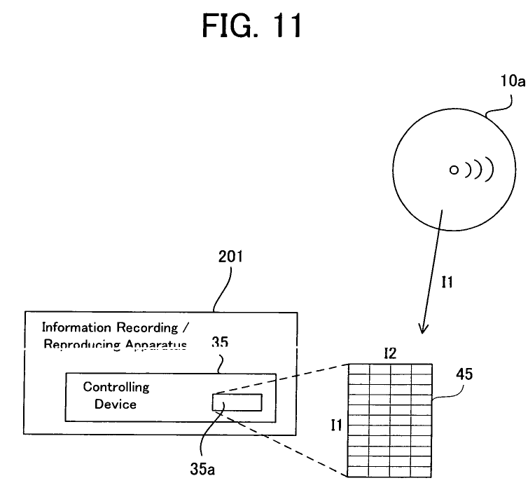

Next, the second embodiment of the present invention will be explained with reference to FIG. 11. FIG. 11 shows the operation of an optical disc and an information recording/reproducing apparatus in the second embodiment. Incidentally, in the second embodiment, the same constituent elements carry the same reference numerals, and the explanations of them will be omitted as occasion demands.

In FIG. 11, first optical information I1 is recorded in advance on an optical disc 10a in the second embodiment, wherein the first optical information I1 defines the offset value and is related to the optical disc 10a itself. As the first optical information I1, the thickness and refractive index (or transmittance) of the transparent substrate 106, the thickness of an intermediate layer between the L0 layer and the L1 layer, and the refractive index (or transmittance) of the intermediate layer, and the like are listed, for example.

On the other hand, an information recording/reproducing apparatus 201 possesses second optical information I2 which defines the offset value and which is related to the optical head 22, in advance. As the second optical information I2, the numerical aperture NA of the objective lens 22a, the wavelength of the laser light LB, and the like are listed, for example. Specifically, the controller 35 is provided with a memory 35a, and the second optical information 12 is stored in the memory 35a in a form of a table 45. The table 45 is provided with the second optical information I2 which is known and the first optical information I1 which is treated as a variable. By introducing the first optical information I1, the offset value can be obtained.

As shown in FIG. 11, the first optical information I1 is read by the information recording/reproducing apparatus 201, and is referred on the table 45 by the controller 35. As a result, the offset value written on the table 45 in advance is selected uniquely by the first optical information I1 and the second optical information I2.

The controller 35 may perform such a control that the focus position of the objective lens 22a is shifted from the focus point F1 by the offset value obtained in this manner before the writing.

As described above, according to the second embodiment, the offset value is obtained on the basis of the first optical information I1 and the second optical information I2. Thus, as compared to the first embodiment, it is possible to reduce a time and a load for the correction of the focus position in the writing. Moreover, the offset value is obtained on the basis of the optical conditions of both the disc side and the apparatus side. Thus, it is possible to correct the focus position, more realistically.

(Third Embodiment)

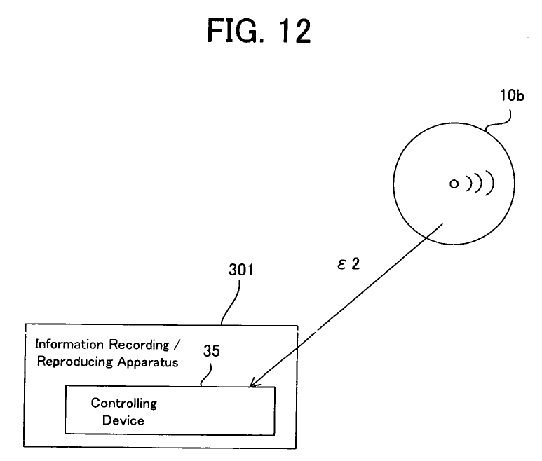

Next, the third embodiment of the present invention will be explained with reference to FIG. 12. FIG. 12 shows the operation of an optical disc and an information recording/reproducing apparatus in the third embodiment.

In FIG. 12, an offset value ε2 itself is recorded in advance on an optical disc 10b in the third embodiment. Namely, the offset value ε2 obtained in advance in the same procedure as in the first embodiment is recorded on the optical disc 10b.

In this case, as shown in FIG. 12, as soon as read by an information recording/reproducing apparatus 301, the offset value ε2 is used for the correction of the focus position. Namely, the offset value ε2 is possessed by each optical disc 10b as peculiar information. And it is enough to merely read the offset value ε2 from the optical disc 10b, in order to obtain the offset value appropriate for each disc.

The present invention has been explained by giving the embodiments. The information recording medium and the information recording apparatus of the present invention are not limited to the above-mentioned embodiments, but can be modified variously. For example, as for the correction of the focus position of the objective lens, if the objective lens is a normal fixed focus lens, a distance between the objective lens and the information recording medium may be changed by shifting the objective lens. If the objective lens is a focus-distance variable lens, such as a liquid lens, an application voltage or the like may be changed, instead of shifting the position of the lens.

Moreover, the information recording medium of the present invention can be applied to a medium which has a large influence of aberration. It is not limited to a two-layer one side, i.e. a dual layer, and may be a two-layer double side, i.e. a dual layer double side. Moreover, the recording layer is not limited to the two layers, as described above, but may be a single-layer, or three or more layers.

Moreover, in the first embodiment, the position of the objective lens in focusing onto the offset reference medium is measured at each time of the writing operation. However, it may be recorded on the information recording apparatus or the information recording medium to use it when needed. The position coordinates of the reference point of the focus position which is displaced in the test writing in order to set the offset value ε1 may be also recorded on the information recording apparatus or the information recording medium. Moreover, the offset value ε1 itself which is set may be recorded on the information recording apparatus or the information recording medium.

Incidentally, in each embodiment, the information recording/reproducing apparatus has been explained as one example of the information recording apparatus of the present invention. The information recording apparatus, however, may be constructed as a system in which the RF signal processor 24, the demodulator 25, and the output device 31 are removed.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2004-198400 filed on Jul. 5, 2004 including the specification, claims, drawings and summary is incorporated herein by reference in its entirety.

What is claimed is:

1. An information recording apparatus comprising:
an optical head which can optically write information onto an information recording medium;
a focusing device for performing such focusing that a focus position of said optical head is set onto a recording reference plane of the information recording medium; and
a controlling device for controlling said focusing device to shift the focus position from the recording reference plane by an offset value and controlling said optical head to perform writing in such a condition that the focus position is shifted.

2. The information recording apparatus according to claim 1, wherein the offset value is set on the basis of a central point of a focus S-shaped curve in a signal waveform of a focus error signal which is used when said focusing device performs the focusing.

3. The information recording apparatus according to claim 1, wherein
the offset value is recorded in advance on the information recording medium,
said optical head can read the information from the information recording medium, and
said controlling device controls said focusing device to shift the focus position by the offset value which is read by said optical head from the information recording medium.

4. The information recording apparatus according to claim 1, wherein
first optical information which defines the offset value and which is related to the information recording medium is recorded in advance on the information recording medium,
said optical head can read the information from the information recording medium, and
said controlling device possesses second optical information which defines the offset value and which is related to said optical head, in advance, and sets the offset value on the basis of the first optical information which is read by said optical head from the information recording medium and the second optical information possessed in advance.

5. The information recording apparatus according to claim 1, wherein
said optical head can read the information from the information recording medium, and
said controlling device controls said optical head and said focusing device to perform writing at each of a plurality of points on the information recording medium while changing the focus position, controls said optical head to read the information from the plurality of points, obtains a predetermined type of a reproduction feature related to a reproduction signal corresponding to the read information, and sets the offset value on the basis of the obtained reproduction feature.

6. The information recording apparatus according to claim 5, wherein the reproduction feature is at least one of a radial push-pull value, an asymmetry value, modulated amplitude, and a jitter value.

7. The information recording apparatus according to claim 6, wherein a focus position which satisfies at least any one of such conditions of the reproduction feature that (i) the asymmetry is the maximum, (ii) the modulated amplitude is the maximum, and (iii) the jitter value is the minimum, is set as the offset value.

8. The information recording apparatus according to claim 5, wherein said controlling device controls said focusing device to change the focus position on the basis of a position where the focusing is performed on an offset reference medium, in writing which is performed at the time of setting the offset value.

9. The information recording apparatus according to claim 5, wherein said controlling device controls said focusing device to change the focus position on the basis of a position where the radial push-pull value is the maximum in an unrecorded portion of the information recording medium, in writing which is performed at the time of setting the offset value.

10. The information recording apparatus according to claim 5, wherein said controlling device controls said focusing device to change the focus position on the basis of a position where the reproduction feature is optimized in a written portion or a pre-written portion of the information recording medium, in writing which is performed at the time of setting the offset value.

11. The information recording apparatus according to claim 5, wherein said controlling device controls said optical head and said focusing device to perform Optimum Power Control (OPC) processing, at least one time of before writing which is performed at the time of setting the offset value and after shifting the focus position by the offset value.

12. The information recording apparatus according to claim 1, wherein said controlling device controls said optical head and said focusing device to write the set offset value onto the information recording medium.

13. The information recording apparatus according to claim 1, wherein if the information recording medium comprises a plurality of recording layers, said controlling device controls said focusing device to shift the focus position by the offset value, with respect to each recording reference plane of the plurality of recording layers.

14. An information recording medium onto which information can be optically written by an optical head provided for an information recording apparatus,
said information recording medium comprising:
a writing area to record therein an offset value which is set to correct a focus position of the optical head, or optical information of itself which defines the offset value.

15. An information recording medium comprising:
a writing area into which information can be optically written by an optical head provided for an information recording apparatus, wherein
an offset value which is set to correct a focus position of the optical head, or optical information of itself which defines the offset value is recorded in advance in said writing area.

16. The information recording medium according to claim 14, wherein
said information recording medium comprises a plurality of recording layers, each of which has the writing area, and
the offset value or the optical information with respect to each layer of the plurality of recording layers is a recording object in at least one of the writing areas of the plurality of the recording layers.

17. The information recording medium according to claim 15, wherein
said information recording medium comprises a plurality of recording layers, each of which has the writing area, and
the offset value or the optical information with respect to each layer of the plurality of recording layers is a recording object in at least one of the writing areas of the plurality of the recording layers.
